(19) United States
(12) Patent Application Publication
(10) Pub. No.: US 2014/0365681 A1
(43) Pub. Date: Dec. 11, 2014

(54) DATA MANAGEMENT METHOD, DATA MANAGEMENT SYSTEM, AND DATA MANAGEMENT APPARATUS

(71) Applicant: FUJITSU LIMITED, Kawasaki-shi (JP)

(72) Inventors: Kei Hamada, Fukuoka (JP); Ryohei Yokoyama, Fukuoka (JP)

(73) Assignee: FUJITSU LIMITED, Kawasaki-shi (JP)

(21) Appl. No.: 14/293,241

(22) Filed: Jun. 2, 2014

(30) Foreign Application Priority Data
Jun. 6, 2013 (JP) 2013-120260

(51) Int. Cl. H04L 12/803

(52) U.S. Cl. CPC H04L 47/125
USPC 709/235

(57) ABSTRACT

A data management method includes acquiring, by a management computer, information of an amount of resource load from a plurality of computers; when a first computer having a higher amount of load than a threshold value is detected in a first area to which a first computer belongs, generating, by the management computer, a second identification range of identifier values by adding a first identification range of a first area to which the detected first computer belongs to a first identification range of a second area different from the first area; calculating, by the first computer, a first target identification of a second computer in the second area corresponding to the first data, based on the first identification ranges and the second identification range, when an operation request for first data is received; and transferring, by the first computer, the operation request for the first data to the second computer.

### CROSS-REFERENCE TO RELATED APPLICATION

This application is based upon and claims the benefit of priority of the prior Japanese Patent Application No. 2013-120260, filed on Jun. 6, 2013, the entire contents of which are incorporated herein by reference.

### FIELD

The embodiment discussed herein is related to a data management method, a data management system, and a data management apparatus.

### BACKGROUND

If only a single data center collects data in a data collection system configured to collect a vast amount of data, a network on the data center becomes a bottleneck. If a database storing data is a single node, the capacity or throughput of the database lacks scalability. For this reason, the data collection system of the embodiment includes a distributed database (hereinafter referred to as distributed DB) in which a database collecting and storing data is distributed, and includes a distributed node group on a per area basis. Related art techniques are disclosed in Japanese Laid-open Patent Publication No. 2003-216474, and Japanese Laid-open Patent Publication No. 2009-230686, for example.

However, if load concentrates on a distributed DB node group of a given area in the distributed DB, it is difficult to distribute the load over a distributed DB node of another area. The resource usage efficiency of the entire distributed DB is decreased. The distributed DB may include a single distributed DB node group as a whole system, and a single management server. The usage of a network bandwidth of the management server increases.

### SUMMARY

According to an aspect of the invention, a data management method of a data management system including a plurality of computers capable communication over a network, and a management computer configured to manage the computers over the network, the computers belonging to respective areas, first identification ranges representing ranges of identifier values, the first identification ranges respectively allocated to the plurality of computers, the data management method includes acquiring, by the management computer, information of an amount of resource load from the plurality of computers; when a first computer having a higher amount of load than a threshold value is detected in a first area to which the first computer belongs, generating, by the management computer, a second identification range of identifier values by adding a first identification range of the first area to which the detected first computer belongs to a first identification range of a second area different from the first area; calculating, by the first computer, a first target identification of a second computer in the second area corresponding to first data, based on the first identification ranges and the second identification range, when an operation request for first data is received; and transferring, by the first computer, the operation request for the first data to the second computer.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a configuration of a data management system of an embodiment;

FIG. 2 is a block diagram illustrating an example of a management node of the embodiment;

FIG. 3 illustrates an example of a static area information storage unit;

FIG. 4 illustrates an example of a node information storage unit;

FIG. 5 illustrates an example of an identification (ID) node information storage unit;

FIG. 6 illustrates an example of a dynamic area information storage unit;

FIG. 7 is a block diagram illustrating an example of a node of the embodiment;

FIG. 8 illustrates an example of a data storage unit;

FIG. 9 illustrates an example of a location storage unit;

FIG. 10 illustrates an example of a redistribution storage unit;

FIG. 11 is a block diagram illustrating an example of an accumulation client of the embodiment;

FIG. 12 is a block diagram illustrating an example of an analysis server of the embodiment;

FIG. 13 is a block diagram illustrating an example of a hardware configuration of a node of the embodiment;

FIG. 14 illustrates an example of a relationship of a static ID, an area, and a node;

FIG. 15 illustrates an example of a relationship of a dynamic ID, an area, and a node;

FIG. 16 is a sequence chart of an example of an initial setting operation of the embodiment;

FIG. 17 is a sequence chart of an example of an operation of an update request and a reference request of the embodiment;

FIG. 18 is a flowchart illustrating an operation example of the node of the embodiment during update request reception;

FIG. 19 is a flowchart illustrating an operation example of the node of the embodiment during reference request reception; and

FIG. 20 illustrates an example of a data management apparatus that executes a data management program.

### DESCRIPTION OF EMBODIMENT

A data management method, a data management program, a data management system, and a management apparatus of an embodiment are described below with reference to the drawings. The embodiment is not intended to limit techniques disclosed therein. The embodiment described below may be combined as long as such a combination is consistent.

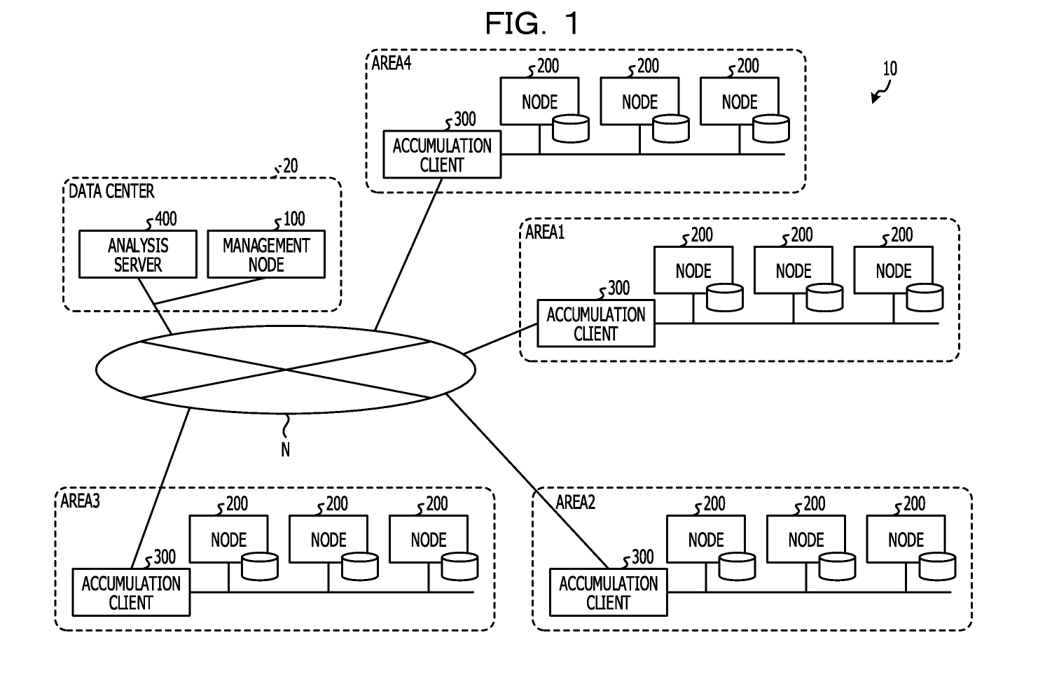

FIG. 1 illustrates an example of a configuration of a data management system of an embodiment. A data management system 10 includes a data center 20, and area 1 through area 4 representing distributed database (DB) groups. The data center 20 includes a management node 100 and an analysis server 400. Each of the areas 1 through 4 includes nodes 200 and an accumulation client 300. The management node 100, the accumulation client 300 of each of the areas 1 through 4, and the analysis server 400 are wire-connected to each other for communications via a network N. The nodes 200 in each of the areas 1 through 4 are connected to the accumulation client 300 in the area to which the nodes 200 belong. For example, the management node 100 is a second node, and the node 200 is a first node.

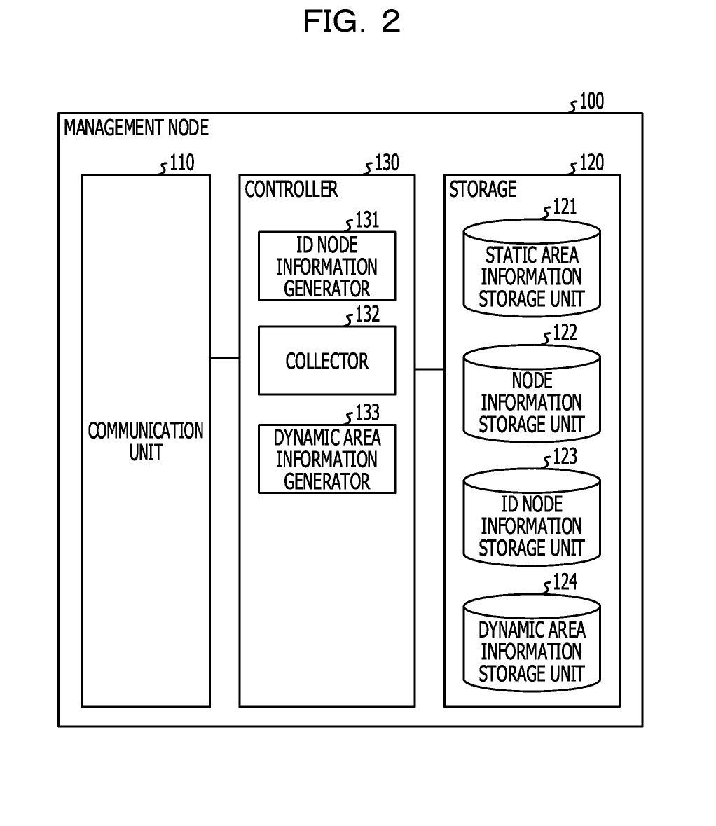

The configuration of the management node 100 is described below. FIG. 2 is a block diagram illustrating an example of the configuration of the management node 100 of the embodiment. The management node 100 includes a communication unit 110, a storage 120, and a controller 130. The management node 100 generates information to distribute a node responsive to a request, using an identification (ID) identifying data and information identifying an area. The management node 100 may include an input unit (such as a keyboard or a mouse) that receives a variety of operations input by the administrator of the management node 100, or a display unit (such as a liquid-crystal display) that displays a variety of information.

The communication unit 110 may be implemented by a network interface card (NIC) or the like. The communication unit 110 is an interface that is connected to a network N and controls communications with the node 200, the accumulation client 300, and the analysis server 400 via the network N.

The storage 120 may be implemented by a semiconductor memory, such as a random access memory (RAM) or a flash memory, or a storage device, such as a hard disk or an optical disk. The storage 120 includes a static area information storage unit 121, a node information storage unit 122, an ID node information storage unit 123, and a dynamic area information storage unit 124.

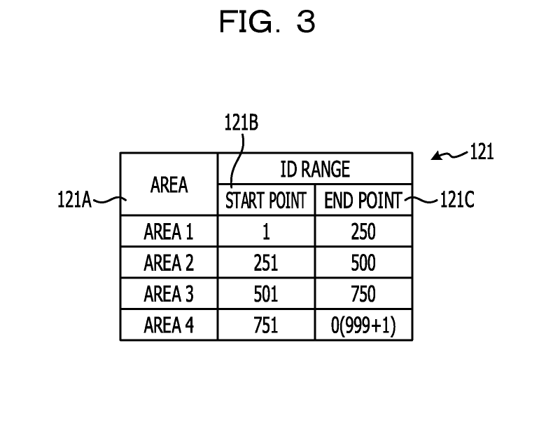

The static area information storage unit 121 stores static area information that allocates a positional relationship of each area to an ID space. FIG. 3 illustrates an example of the static area information storage unit. As illustrated in FIG. 3, the static area information storage unit 121 manages items in association with each other, including an area 121A, and a start point 121B and an end point 121C of an ID range.

The area 121A indicates a distributed DB node group of each area. As illustrated in FIG. 3, for example, the area 121A includes four areas, namely, area 1 through area 4. The start point 121B of the ID range is a static ID of the start point of each area allocated to the ID space. The end point 121C of the ID range is a static ID of the end point of each area allocated to the ID space. The static ID is a second ID. As illustrated in FIG. 3, the entire space is represented by “1-1000 (represented by 0)”, IDs “1-250” are allocated to the area 1, IDs “251-500” are allocated to the area 2, IDs “501-750” are allocated to the area 3, and the IDs “751-0” are allocated to the area 4.

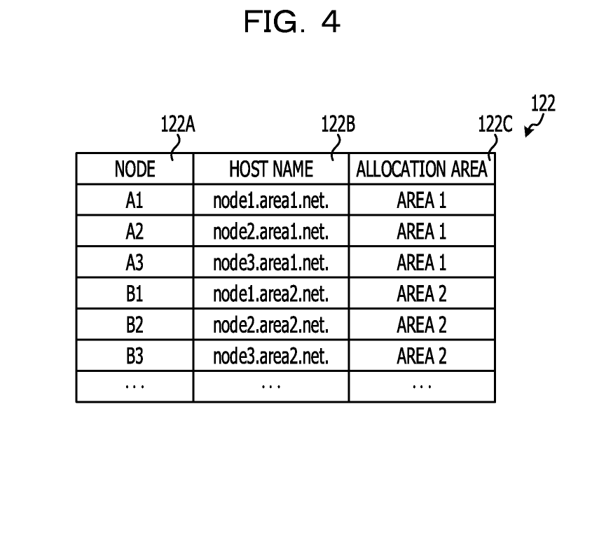

The node information storage unit 122 stores node information that associates a node, the host name of the node, and an allocation area of the node. FIG. 4 illustrates an example of the node information storage unit. Referring to FIG. 4, the node information storage unit 122 manages items in association therewith, including a node 122A, a host name 122B, and an allocation area 122C.

The node 122A is identification information identifying each node. The host name 122B is information identifying each node over the network. The allocation area 122C indicates an area to which each node belongs. The nodes 200 of “A1”, “A2”, and “A3” belong to the area 1 of the allocation area 122C of FIG. 4. The nodes 200 of “B1”, “B2”, and “B3” belong to the area 2 of the allocation area 122C.

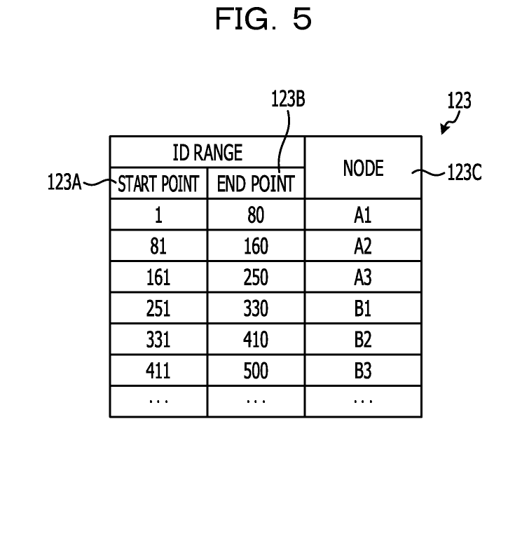

The ID node information storage unit 123 stores ID node information that associates a static ID range of the ID space with a node. The ID node information indicates the ID range of all the areas, and associates the static ID with each node 200 of all the areas. FIG. 5 illustrates an example of the ID node information storage unit. As illustrated in FIG. 5, the ID node information storage unit 123 manages items in association with each other, including a start point 123A of the ID range, an end point 123B of the ID range, and a node 123C.

The start point 123A indicates a static ID of a start point of each node allocated to the ID space. The end point 123B indicates a static ID of an end point of each node allocated to the ID space. The node 123C indicates a node corresponding to the ID range. As illustrated in FIG. 5, for example, IDs “1-80” correspond to the node 200 of “A1”. IDs “81-160” correspond to the node 200 of “A2”. IDs “161-250” correspond to the node 200 of “A3”. IDs “251-330” correspond to the node 200 of “B1”. IDs “331-410” correspond to the node 200 of “B2”. IDs “411-500” correspond to the node 200 of “B3”.

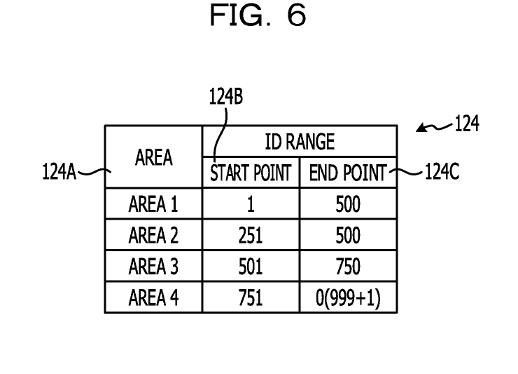

The dynamic area information storage unit 124 stores dynamic area information that manages the ID space and the dynamic ID in association with each other on a per area basis. The dynamic ID is a first ID, and the dynamic area represents a derivation enabled range from which the dynamic ID is derived. FIG. 6 illustrates an example of the dynamic area information storage unit. Referring to FIG. 6, the dynamic area information storage unit 124 manages items in association with each other, including an area 124A, a start point 124B of the ID range, and an end point 124C of the ID range.

The area 124A indicates a distributed DB node group on a per area basis. As illustrated in FIG. 6, for example, four areas, area 1 through area 4 are listed in the area 124A. The start point 124B indicates a dynamic ID of a start point of each area allocated to the ID space. The end point 124C indicates a dynamic ID of an end point of each area allocated to the ID space. As illustrated in FIG. 6, for example, the entire ID space is represented by “1-1000 (represented by 0)”. IDs “1-500” are allocated to the area 1, IDs “251-500” are allocated to the area 2, IDs “501-750” are allocated to the area 3, and IDs “751-0” are allocated to the area 4. IDs “251-500” are used not only for the area 2 but also as the dynamic IDs for the area 1.

Returning to the discussion of FIG. 2, the controller 130 is implemented by a central processing unit (CPU) or a micro processing unit (MPU). The CPU or the MPU executes a program stored on an internal storage device using a working area of a random-access memory (RAM). Alternatively, the controller 130 may be an integrated circuit, such as an application specific integrated circuit (ASIC) or a field programmable gate array (FPGA).

As illustrated in FIG. 2, the controller 130 includes an ID node information generator 131, a collector 132, and a dynamic area information generator 133. The controller 130 executes an information processing process described below. The internal structure of the controller 130 is not limited to the structure of FIG. 2, and may have another structure as long as the information processing process described below is performed.

The ID node information generator 131 generates ID node information based on the static area information stored on the static area information storage unit 121 and the node information stored on the node information storage unit 122. To generate the ID node information, the ID node information generator 131 calculates a primary ID from the node name of each node using the hash function, and then calculates a node ID in accordance with the following Equation (1). The ID node information generator 131 then arranges all the nodes in accordance with the node ID order, and then generates the ID node information by setting a range of a target node to be a range larger than the node ID of a previous node but equal to or below the node ID of the management node 100.

Node ID=primary ID×static ID range of allocation area of node/entire ID range+static ID of start point of allocation area of node (1)

Described below is how to calculate the node ID from the static area information of FIG. 3 and the node information of FIG. 4. For example, the node ID is calculated if the primary ID of the node 200 of “A2” is “636”. The node 200 of “A2” belongs to the area 1 in accordance with the node information. The static ID range of the area 1 to which the node 200 of “A2” belongs to is “1-250” in accordance with the static area information. The static ID of the start point of the area 1 is “1”. The entire ID range is “1000” in accordance with the static area information. If these parameters are substituted for in Equation (1), the node ID=636×250/1000+1, and the node ID is thus “160”. If the node ID of the node 200 of “A1” is “80”, the static ID range corresponding to the node 200 of “A2” is “81-160”.

The ID node information generator 131 stores the generated ID information onto the ID node information storage unit 123. The ID node information generator 131 transmits the static area information and the ID node information to each node 200, each accumulation client 300, and the analysis server 400 via the communication unit 110.

The collector 132 receives and collects load information transmitted from each node 200 via the communication unit 110. The load information represents an amount of load of each node 200. For example, the load information includes resource usage status information, such as of a CPU usage rate or a disk usage amount of each node 200. The collector 132 outputs the collected load information to the dynamic area information generator 133.

Upon receiving the load information from the collector 132, the dynamic area information generator 133 determines whether any node 200 has an amount of load above a specific amount of load. When the dynamic area information generator 133 detects a node 200 having an amount of load above the specific amount of load, the dynamic area information generator 133 generates a dynamic ID range of the area the node 200 belongs to. The dynamic area information generator 133 generates a dynamic ID range of the area by adding the static ID range of an area adjacent to the area including the node 200 having the amount of load above the specific amount of load, to the static ID range of the area including the node 200 having the amount of load above the specific amount of load. For example, if the amount of load of the node 200 belonging to the area 1 exceeds the specific amount of load as illustrated in FIG. 6, the dynamic area information generator 133 adds IDs “251-500” in the static ID range of the adjacent area (the area 2) to IDs “1-250” of the static ID range of the area 1 for allocation. In other words, IDs “1-500” are allocated as the dynamic IDs to the area 1. The dynamic area information generator 133 generates the dynamic area information by associating the dynamic ID on a per area basis. If the node 200 having an amount of load above the specific amount of load is not detected, the dynamic area information generator 133 generates the same ID range as described in the static area information to be the dynamic area information. The dynamic area information generator 133 stores the generated dynamic area information onto the dynamic area information storage unit 124 while transmitting the dynamic area information to each node 200 via the communication unit 110.

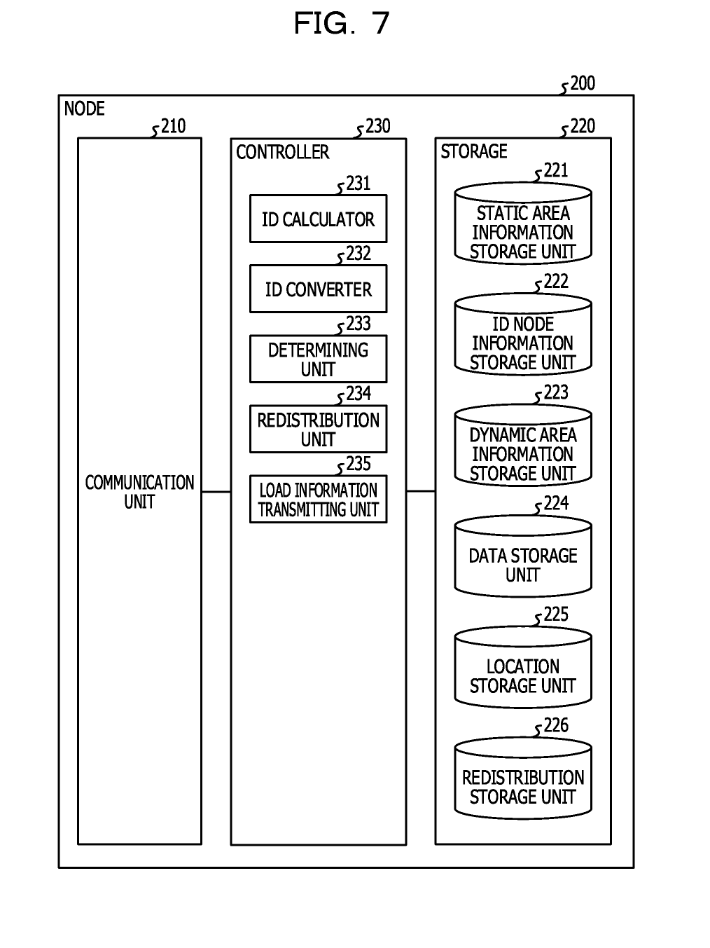

The configuration of the node 200 is described below. FIG. 7 is a block diagram illustrating an example of the node of the embodiment. The node 200 includes a communication unit 210, a storage 220, and a controller 230. The node 200 receives data from the accumulation client 300 that manages the area the node 200 belongs to or from another node 200 and then accumulates the data. The node 200 may include an input unit (such as a keyboard or a mouse) that receives a variety of operations input by the administrator of the node 200, or a display unit (such as a liquid-crystal display) that displays a variety of information.

The communication unit 210 may be implemented by a NIC or the like. The communication unit 210 is wire-connected to the accumulation client 300 that manages the allocation area. The communication unit 210 is a communication interface that controls communication of information with the accumulation client 300 or another node 200 via the accumulation client 300. The communication unit 210 is directly wire-connected to the network N, and is also a communication interface that controls communication of information with the accumulation client 300 or another 200 via the network N.

The storage 220 may be implemented by a semiconductor memory, such as a random access memory (RAM) or a flash memory, or a storage device, such as a hard disk or an optical disk. The storage 220 includes a static area information storage unit 221, an ID node information storage unit 222, a dynamic area information storage unit 223, a data storage unit 224, a location storage unit 225, and a redistribution storage unit 226.

The static area information storage unit 221 stores static area information. The static area information is received from the management node 100 via the communication unit 210 and is used to manage the area 121A, the start point 121B of the ID range and the end point 121C of the ID range in association with each other as illustrated in FIG. 3. The static area information is identical in content to the static area information stored on the static area information storage unit 121 in the management node 100.

The ID node information storage unit 222 stores the ID node information. The ID node information is received from the management node 100 via the communication unit 210 and is used to manage the start point 123A of the ID range, the end point 123B of the ID range and the node 123C in association with each other as illustrated in FIG. 5. The ID node information is identical in content to the ID node information stored on the ID node information storage unit 123.

The dynamic area information storage unit 223 stores the dynamic area information. The dynamic area information is received from the management node 100 via the communication unit 210 and is used to manage the area 124A, the start point 124B of the ID range and the end point 124C of the ID range in association with each other as illustrated in FIG. 6. The dynamic area information is identical in content to the dynamic area information stored on the dynamic area information storage unit 124 in the management node 100.

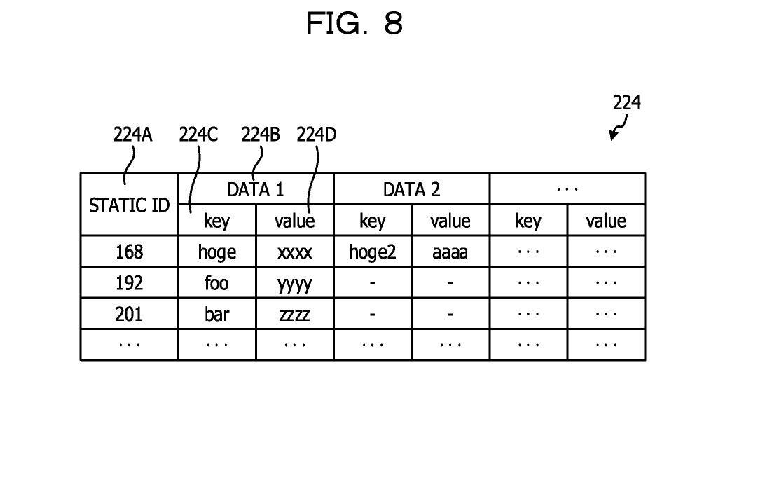

The data storage unit 224 stores data received from the accumulation client 300 of the allocation area via the communication unit 210. FIG. 8 illustrates an example of the data storage unit. As illustrated in FIG. 8, the data storage unit 224 stores a static ID 224A, data 224B, and the like in association with each other. The data 224B includes a key 224C and a value 224D. The static ID 224A is a second ID.

The static ID 224A is identification information that identifies data to be stored on the node 200. The static ID 224A is any static ID within the ID range of the static area information received from the management node 100 via the communication unit 210. A single static ID 224A is stored with a plurality of pieces of data associated therewith. The data 224B indicates data to be stored. The key 224C (hereinafter also referred to as a “key”) is a character string indicating part of the data to be accumulated. The key 224C together with the static ID 224A identifies each piece of data. More specifically, the static ID 224A and the key 224C are used to uniquely identify the data. The value 224D is data itself to be accumulated. The value 224D is talk data of a telephone line, for example.

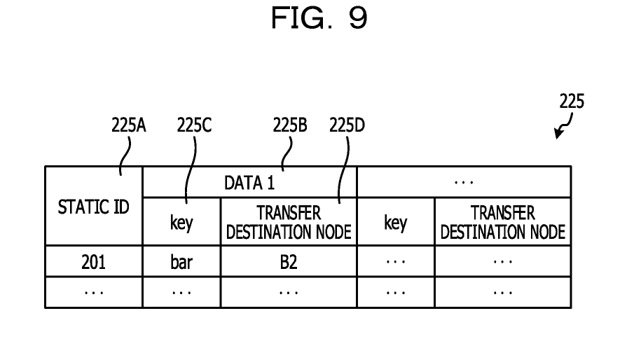

A request, from among requests to accumulate data on the node 200, may be transferred to another node 200 as a transfer destination. The location storage unit 225 stores the node 200 as the transfer destination. FIG. 9 illustrates an example of the location storage unit. As illustrated in FIG. 9, the location storage unit 225 manages a static ID 225A and data 225B in association with each other. The data 225B includes a key 225C and a transfer destination node 225D.

The static ID 225A is identification information to identify data corresponding to a request transferred to another node 200. The static ID 225A is any static ID within the ID range of the static area information received from the management node 100 via the communication unit 210. A single static ID 225A is stored with a plurality of pieces of data associated therewith. The data 225B indicates data to be accumulated. The key 225C is a character string of part of the data to be accumulated. As in the data storage unit 224, the data 225B together with the static ID 225A identifies data. The transfer destination node 225D indicates a node 200 as a destination of the request. The transfer destination node 225D may have a node name, such as “B2”.

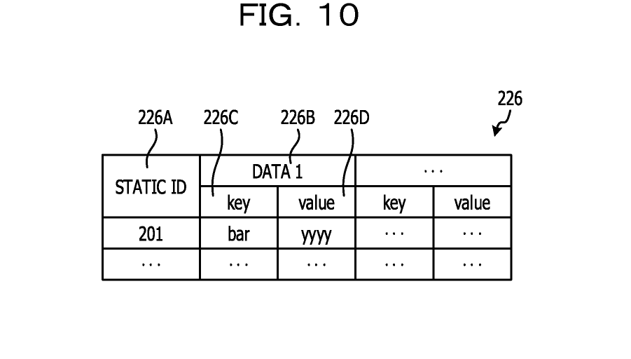

The redistribution storage unit 226 stores data corresponding to the request transferred from another node 200. FIG. 10 illustrates an example of The redistribution storage unit. As illustrated in FIG. 10, the redistribution storage unit 226 manages a static ID 226A and data 226B in association with each other. The data 226B includes a key 226C and a value 226D.

The static ID 226A is identification information that identifies data corresponding to the request transferred from the other node 200. The static ID 226A is any static ID in the ID range of the static area information received from the management node 100 via the communication unit 210. A single static ID 226A is stored with a plurality of pieces of data associated therewith. The data 226B indicates data to be accumulated. The key 226C is a character string representing the data to be accumulated. As in the data storage unit 224, the key 226C together with the static ID 226A identifies each piece of data. The value 226D is data itself to be accumulated. The value 226D is talk data of a telephone line, for example.

Returning back to the discussion of FIG. 7, the controller 230 is implemented by a CPU or an MPU. The CPU or the MPU executes a program stored on an internal storage device using a working area of a RAM. Alternatively, the controller 230 may an integrated circuit, such as an ASIC or an FPGA, for example.

As illustrated in FIG. 7, the controller 230 includes an ID calculator 231, an ID converter 232, a determining unit 233, a redistribution unit 234, and a load information transmitting unit 235. The controller 230 executes an information processing process described below. The internal structure of the controller 230 is not limited to the structure of FIG. 7, and may have another structure as long as the information processing process described below is performed.

The ID calculator 231 receives via the communication unit 210 a request to update data from the accumulation client 300 or a request to reference data from the analysis server 400 and calculates the static ID of the data. The ID calculator 231 is a detector, for example. The ID calculator 231 calculates the static ID of the data based on a key of the data included in the request and the static area information stored on the static area information storage unit 221. The ID calculator 231 calculates a primary ID from the key of the data using the hash function, for example. The ID calculator 231 calculates the static ID of the data in accordance with the following Equation (2). The static ID of the data is a second ID of the data.

Static ID of data=primary ID×static ID range of allocation area of node/entire ID range+static ID of start point of allocation area of node (2)

The node 200 located in the area 1 may now calculate the static ID of the data based on the static area information of FIG. 3 and a calculated primary ID “800”. The static ID range of the area the node 200 belonging to is determined to be “250” based on the static area information. The static ID of the start point of the area 1 is “1”. The entire ID range is determined to be “1000” based on the static area information. If these values are substituted in Equation (2), the static ID of the data=800×250/1000+1. The static ID of the data is thus “201”. The ID calculator 231 outputs the generated static ID of the data to the ID converter 232 and the determining unit 233.

Upon receiving from the determining unit 233 dynamic ID generation information to be described later, the ID converter 232 converts the static ID of the data to a dynamic ID. The ID converter 232 calculates the dynamic ID of the data based on the primary ID used to calculate the static ID of the data and the dynamic area information stored on the dynamic area information storage unit 223. In other words, the ID converter 232 is a calculator, for example. The ID converter 232 calculates the dynamic ID of the data in accordance with the following Equation (3). The dynamic ID of the data is a first ID of the data.

Dynamic ID of data=primary ID×dynamic ID range of allocation area of node/entire ID range+dynamic ID of start point of allocation area of node (3)

The node 200 located in the area 1 calculates the dynamic ID of the data based on the dynamic area information of FIG. 6 and “800” calculated as the primary ID as described below. The dynamic ID range of the data of the allocation area of the node 200 is determined to be “500” based on the dynamic area information. The dynamic ID of the start point of the area 1 is “1”. The entire ID range is determined to be “1000” based on the dynamic area information. If these parameters are substituted in Equation (3), the dynamic ID of the data=800×500/1000+1. The dynamic ID of the data is thus “401”. The ID converter 232 outputs the generated dynamic ID of the data to the determining unit 233.

The determining unit 233 receives via the communication unit 210 a request to update the data from the accumulation client 300 or a request to reference the data from the analysis server 400. The determining unit 233 receives the static ID of the data from the ID calculator 231. Based on the static ID and the key of the data of the request, the determining unit 233 determines whether the data corresponding to the request is stored on the data storage unit 224. If the data corresponding to the request is stored on the data storage unit 224, the determining unit 233 references or updates the data. Upon referencing the data, the determining unit 233 transmits a reference response to the analysis server 400. Upon updating the data, the determining unit 233 transmits an update response to the accumulation client 300.

If the data corresponding to the request is not stored on the data storage unit 224, the determining unit 233 searches the position storage unit 225 for the static ID and the key of the data of the request to determine whether the node 200 as the transfer destination is stored on the location storage unit 225. If the node 200 as the transfer destination responsive to the request is stored on the location storage unit 225, the determining unit 233 transfers the request to the node 200 as the transfer destination hit in the determination via the communication unit 210. Upon receiving a reference response from the node 200 as the transfer destination, the determining unit 233 transfer the reference response to the analysis server 400. Upon receiving an update response from the node 200 as the transfer destination, the determining unit 233 transfers the reference response to the accumulation client 300.

If the transfer destination node 200 corresponding to the request is not stored on the location storage unit 225, the determining unit 233 outputs the dynamic ID generation information to the ID converter 232. Upon receiving the dynamic ID of the data from the ID converter 232, the determining unit 233 references (searches for) the ID node information stored on the ID node information storage unit 222. Based on the search results of the ID node information, the determining unit 233 determines as the transfer destination node 200 the node 200 to which the static ID corresponding to the dynamic ID of the data is allocated. The determining unit 233 stores the determined node 200 as the transfer destination node 200 on the location storage unit 225. The determining unit 233 transfers the request to the transfer destination node 200 via the communication unit 210. Upon receiving an update response from the transfer destination node 200, the determining unit 233 transfers the update response to the accumulation client 300. In other words, the determining unit 233 operates as a detector, a determining unit, and a transfer unit.

The redistribution unit 234 receives the request transferred from another node 200 via the communication unit 210. Upon receiving the transferred update request, the redistribution unit 234 allows the data to be transmitted to the accumulation client 300 serving as a transmission source of the request. Upon receiving the data, the redistribution unit 234 stores the data on the redistribution storage unit 226. Upon storing the data on the redistribution storage unit 226, the redistribution unit 234 transmits an update response to the transfer source node 200 via the communication unit 210. Upon receiving a transferred reference request, the redistribution unit 234 transmits the data to the analysis server 400 as a transmission source of the request. Upon transmitting the data, the redistribution unit 234 transmits a reference response to the transfer source node 200 via the communication unit 210.

The load information transmitting unit 235 collects load information of the node 200 itself. The load information transmitting unit 235 transmits the load information to the management node 100 via the communication unit 210. The load information includes resource usage status information, such as of a CPU usage rate or a disk usage amount of each node 200. The CPU usage rate or the disk usage amount may be represented by percentage. The disk usage amount may be a remaining capacity of a disk.

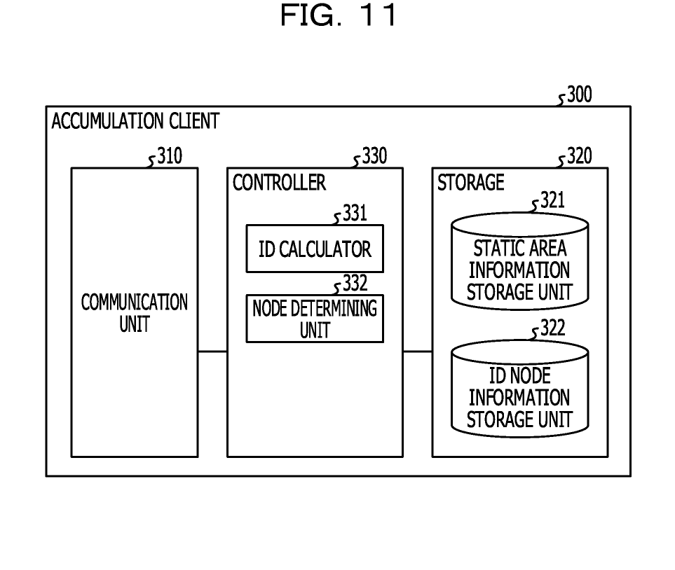

The configuration of the accumulation client 300 is described below. FIG. 11 is a block diagram illustrating an example of the accumulation client of the embodiment. The accumulation client 300 includes a communication unit 310, a storage 320, and a controller 330. Upon acquiring the data of the area to which the accumulation client 300 belongs, the accumulation client 300 transmits an update request of the acquired data to the corresponding node 200. The accumulation client 300 may include an input unit (such as a keyboard or a mouse) that receives a variety of operations input by the administrator of the accumulation client 300, or a display unit (such as a liquid-crystal display) that displays a variety of information.

The communication unit 310 may be implemented by a NIC or the like. The communication unit 310 is wire-connected to the network N. The communication unit 310 is an interface that controls communication of information with the management node 100, the accumulation client 300 in another area, or the analysis server 400 via a network N. The communication unit 310 is connected to each node 200 in the same area, and controls communication of information with each node 200.

The storage 320 may be implemented by a semiconductor memory, such as a RAM or a flash memory, or a storage device, such as a hard disk or an optical disk. The storage 320 includes a static area information storage unit 321 and an ID node information storage unit 322.

The static area information storage unit 321 stores the static area information. The static area information is received from the management node 100 via the communication unit 310, and is used to manage items of FIG. 3 in association with each other, including the area 121A, the start point 121B of the ID range and the end point 121C of the ID range. The static area information is identical in content to the static area information stored on the static area information storage unit 121 in the management node 100.

The ID node information storage unit 322 stores the ID node information. The ID node information is received from the management node 100 via the communication unit 310 and is used to manage items of FIG. 5 in association with each other, including the start point 123A of the ID range, the end point 123B of the ID range, and the node 123C. The ID node information is identical in content to the ID node information stored on the ID node information storage unit 123 in the management node 100.

The controller 330 is implemented by a CPU or an MPU. The CPU or the MPU executes a program stored on an internal storage device using a working area of a RAM. The controller 330 may an integrated circuit, such as an ASIC or an FPGA.

The controller 330 includes an ID calculator 331 and a node determining unit 332 as illustrated in FIG. 11. The controller 330 executes an information processing process described below. The internal structure of the controller 330 is not limited to the structure of FIG. 11, and may have another structure as long as the information processing process described below is performed.

The ID calculator 331 calculates the static ID of data in order to update the data. The ID calculator 331 calculates the static ID of the data based on a key of the data and the static area information stored on static area information storage unit 321. As the ID calculator 231 in the node 200, the ID calculator 331 calculates the static ID of the data. The ID calculator 331 outputs the calculated static ID of the data to the node determining unit 332.

Upon receiving the static ID of the data from the ID calculator 331, the node determining unit 332 determines a destination of an update request to update the data. The node determining unit 332 determines the node 200 as the destination of the update request based on the static ID of the data and the ID node information stored on the ID node information storage unit 322. The node determining unit 332 transmits the update request to the determined node 200 via the communication unit 310. The update request includes a key as a character string indicating part of the data. Upon receiving an update response from the node 200 to which the update request has been transmitted, the node determining unit 332 detects the completion of an accumulation process of the data.

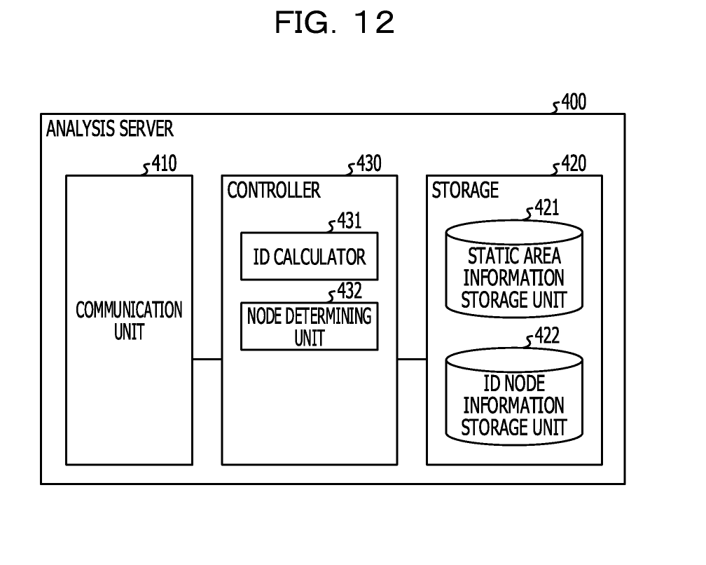

The configuration of the analysis server 400 is described below. FIG. 12 is a block diagram illustrating an example of the analysis server of the embodiment. The analysis server 400 includes a communication unit 410, a storage 420, and a controller 430. The analysis server 400 references and analyzes the data accumulated on each node 200. The analysis server 400 may include an input unit (such as a keyboard or a mouse) that receives a variety of operations input by the administrator of the analysis server 400, or a display unit (such as a liquid-crystal display) that displays a variety of information.

The communication unit 410 may be implemented by a NIC or the like. The communication unit 410 is wire-connected to the network N. The communication unit 410 is an interface that controls communication of information with the accumulation client 300 in another area and each node 200 connected to the accumulation client 300 via the network N. The communication unit 410 is connected to the management node 100 in the same data center 20, and controls communication of information with the management node 100.

The storage 420 may be implemented by a semiconductor memory, such as a RAM or a flash memory, or a storage device, such as a hard disk or an optical disk. The storage 420 includes a static area information storage unit 421 and an ID node information storage unit 422.

The static area information storage unit 421 stores the static area information. The static area information is received from the management node 100 via the communication unit 410, and is used to manage items of FIG. 3 in association with each other, including the area 121A, the start point 121B of the ID range and the end point 121C of the ID range. The static area information is identical in content to the static area information stored on the static area information storage unit 121 in the management node 100.

The ID node information storage unit 422 stores the ID node information. The ID node information is received from the management node 100 via the communication unit 410, and is used to manage items of FIG. 5 in association with each other, including the start point 123A of the ID range, the end point 123B of the ID range, and the node 123C. The ID node information is identical in content to the ID node information stored on the ID node information storage unit 123 in the management node 100.

The controller 430 is implemented by a CPU or an MPU. The CPU or the MPU executes a program stored on an internal storage device using a working area of a RAM. Alternatively, the controller 430 may an integrated circuit, such as an ASIC or an FPGA.

The controller 430 includes an ID calculator 431 and a node determining unit 432 as illustrated in FIG. 12. The controller 430 executes an information processing process described below. The internal structure of the controller 430 is not limited to the structure of FIG. 12, and may have another structure as long as the information processing process described below is performed.

The ID calculator 431 calculates the static ID of data in order to update the data. The ID calculator 431 calculates the static ID of the data based on a key of the data and the static area information stored on the static area information storage unit 421. As the ID calculator 231 in the node 200, the ID calculator 431 calculates the static ID of the data. The ID calculator 431 outputs the calculated static ID of the data to the node determining unit 432.

Upon receiving the static ID of the data from the ID calculator 431, the node determining unit 432 determines a destination of a reference request to reference the data. The node determining unit 432 determines the node 200 as the destination of the reference request based on the static ID of the data and the ID node information stored on the ID node information storage unit 422, and then transmits the reference request to the determined node 200.

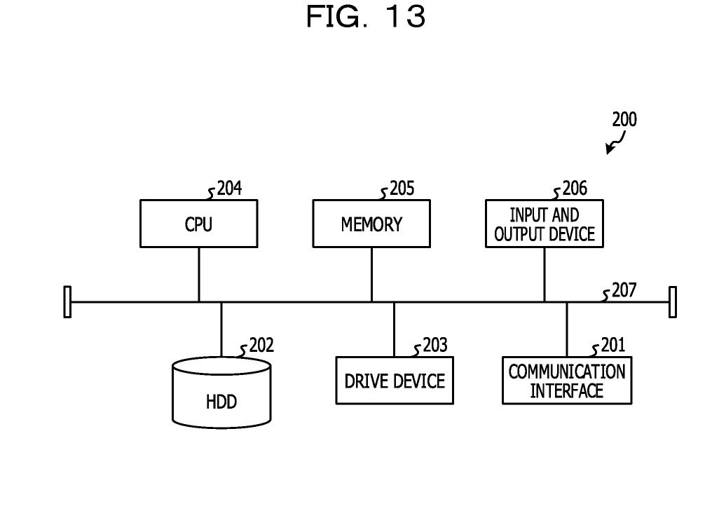

The hardware configuration of the node 200 is described below. FIG. 13 is a block diagram illustrating an example of the hardware configuration of the node of the embodiment.

The node 200 includes a communication interface 201, a hard disk drive (HDD) 202, a drive device 203, a CPU 204, a memory 205, an input and output device 206, and a bus 207 connected to each of those elements. The communication interface 201 corresponds to the communication unit 210. The HDD 202 corresponds to the storage 220, and the use of a redundant arrays of inexpensive disks (RAID) for the HDD 202 increases reliability and operation speed.

The drive device 203 corresponds to the storage 220, and an optical disk or the like may be used for the drive device 203. The CPU 204 corresponds to the controller 230. The memory 205 corresponds to the storage 220, and a semiconductor memory, such as a RAM or a flash memory may be used for the memory 205. The input and output device 206 corresponds to an input unit (such as a keyboard or a mouse) or a display unit (such as a liquid-crystal display). The bus 207 causes information to be transmitted and received among the communication interface 201, the HDD 202, the drive device 203, the CPU 204, the memory 205, and the input and output device 206. For the convenience of explanation, the hardware configuration of the node 200 is described with reference to FIG. 13. The management node 100, the accumulation client 300, and the analysis server 400 may have the same hardware configuration. The discussion of the configuration and operation of these devices is thus omitted herein.

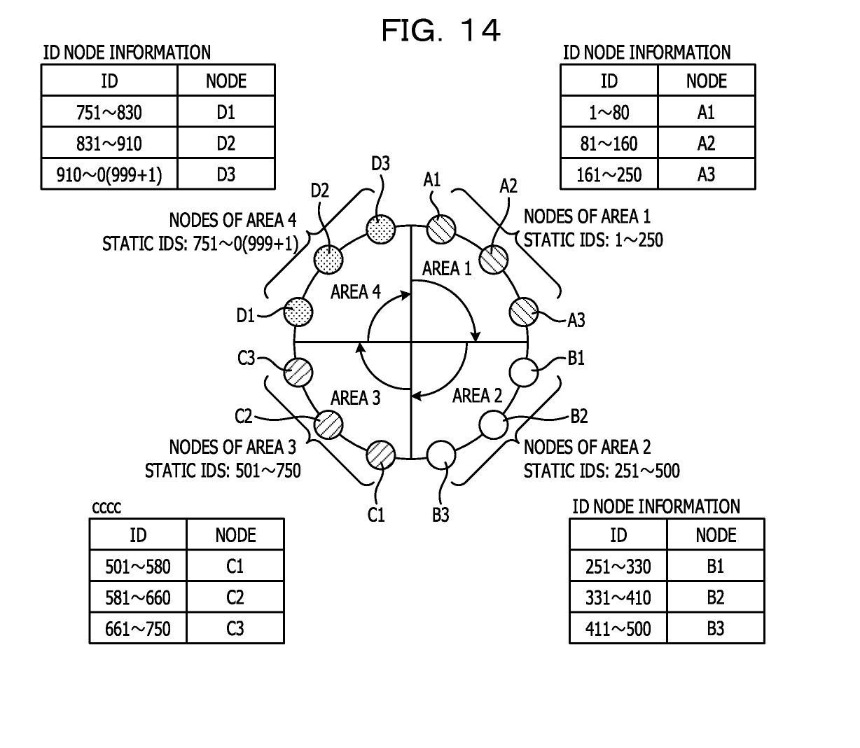

The relationship of the static ID, the area, and the node is described below. FIG. 14 illustrates an example of the relationship of the static ID, the area, and the node. Areas 1 through 4 are geographically located as circular ring sectors. The area 1 is interposed between the area 2 and the area 4. The area 2 is interposed between the area 3 and the area 1. The area 3 is interposed between the area 4 and the area 2. The area 4 is interposed between the area 1 and the area 3.

The area 1 includes “A1”, “A2”, and “A3” as the nodes 200. The area 2 includes “B1”, “B2”, and “B3” as the nodes 200. The area 3 includes “C1”, “C2”, and “C3” as the nodes 200. The area 4 includes “D1”, “D2”, and “D3” as the nodes 200. The static ID range includes “1-1000 (represented by j)” as the entire ID space. IDs “1-250” are allocated to the area 1, IDs “251-500” are allocated to the area 2, IDs “501-750” are allocated to the area 3, and IDs “751-0” are allocated to the area 4. The static ID range in each area are allocated to each node 200. In the area 1, for example, IDs “1-80” are allocated to “A1”, IDs “81-160” are allocated to “A2”, and IDs “161-250” are allocated to “A3”.

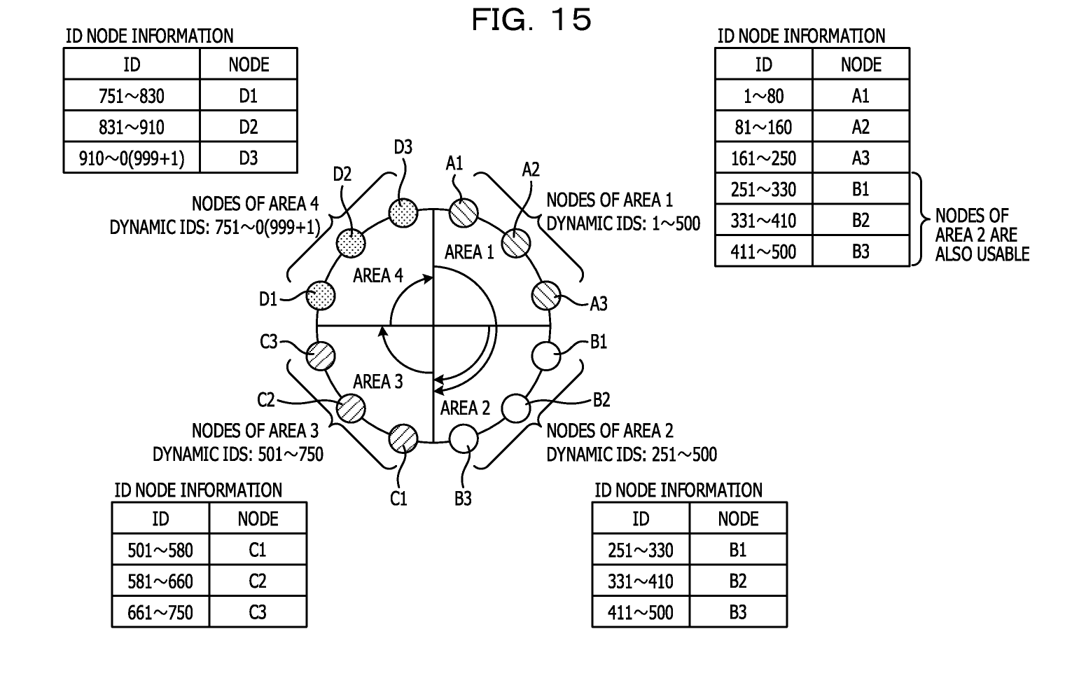

The relationship of the dynamic ID, the area, and the node is described below. FIG. 15 illustrates an example of the relationship of the dynamic ID, the area, and the node. As in the static ID, areas 1 through 4 are geographically located as circular ring sectors. The nodes 200 belong to the areas in the same way as in the static ID. The dynamic ID range includes “1-1000 (represented by 0)” as the entire ID space. IDs “1-500” are allocated to the area 1, IDs “251-500” are allocated to the area 2, IDs “501-750” are allocated to the area 3, and IDs “751-0” are allocated to the area 4. The IDs “251-500” as the static ID range of the area 2 as an adjacent area of the area 1 are added to the area 1 for allocation. In this way, the accumulation client 300 in the area 1 may use the node 200 of the area 2.

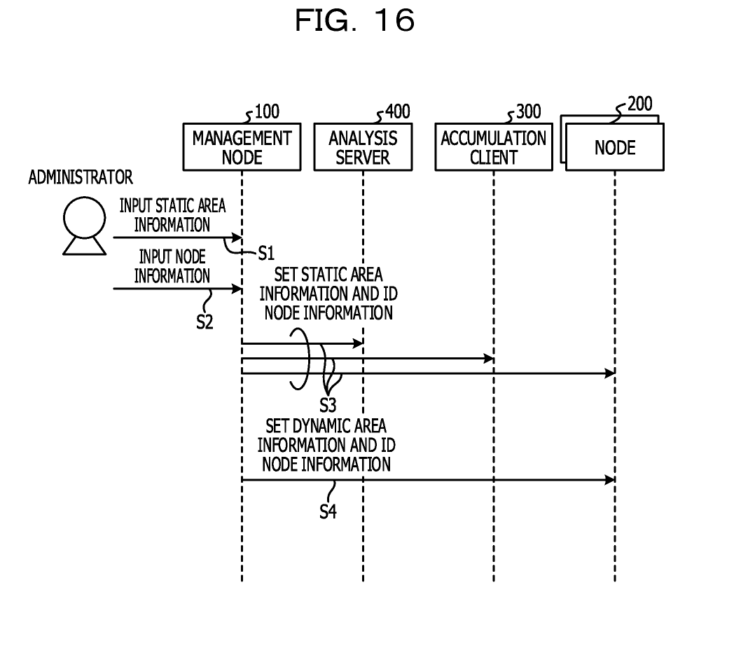

An operation of the data management system 10 of the embodiment is described below. FIG. 16 is a sequence chart of an example of an initial setting operation of the embodiment. The management node 100 receives the static area information from the administrator (S1), and stores the input static area information on the static area information storage unit 121. The management node 100 receives the node information from the administrator (S2). The management node 100 stores the input node information on the node information storage unit 122.

The ID node information generator 131 in the management node 100 generates the ID node information based on the static area information and the node information. The ID node information generator 131 transmits the static area information and the node information to each node 200, each accumulation client 300, and the analysis server 400 via the communication unit 110 (S3). Each node 200, each accumulation client 300, and the analysis server 400 store the received static area information and node information on the static area information storage units 221, 321, and 421, and the ID node information storage units 222, 322, and 422, respectively.

Upon detecting a node 200 having an amount of load above the specific amount of load, the dynamic area information generator 133 in the management node 100 generates the dynamic ID of the area to which that node 200 belongs. If any node 200 having an amount of load above the specific amount of load is not detected, the dynamic area information generator 133 generates the dynamic ID of the data of each area by allocating to each area the same ID range as the static area information of the area. The dynamic area information generator 133 stores the generated dynamic area information on the dynamic area information storage unit 124 while transmitting the dynamic area information to each node 200 via the communication unit 110 (S4). Each node 200 stores the received dynamic area information on the dynamic area information storage unit 223. When the dynamic area information generator 133 detects a node 200 having an amount of load above the specific amount of load, the dynamic area information is re-generated in view of the amount of load, and then transmitted to each node 200.

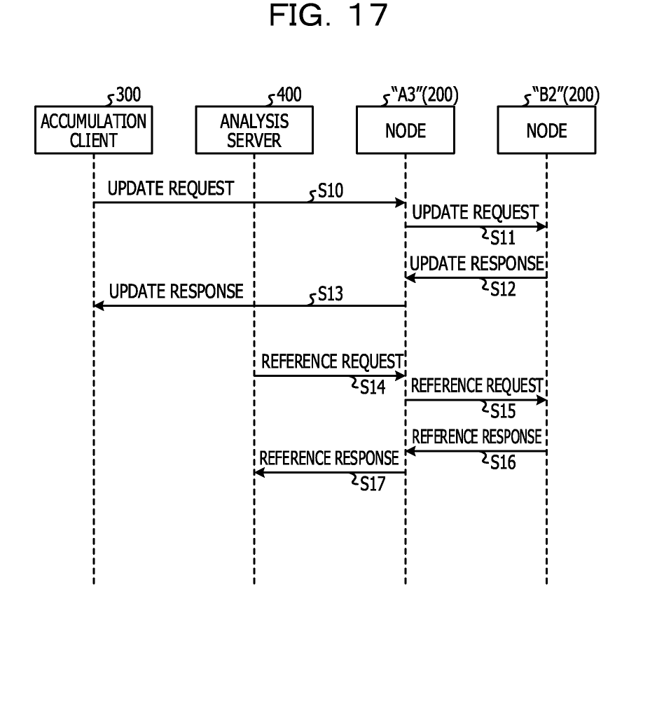

The operation of the data management system 10 performed during the update request and reference request is described. FIG. 17 is a sequence chart of an example of an operation of the update request and reference request of the embodiment. In the sequence described below, the data corresponding to a update request is stored neither on the node 200 of “A3” nor on the node 200 of “B2”, and the update request is transferred from the node 200 of “A3” to the node 200 of “B2”. The data corresponding to a reference request is stored on the node 200 of “B2”, and the reference request is transferred from the node 200 of “A3” to the node 200 of “B2”.

An operation of the update request is described below. In response to the generation of data to be updated, the ID calculator 331 in the accumulation client 300 calculates the static ID of the data based on the key of the data and the static area information stored on the static area information storage unit 321. The ID calculator 331 outputs the calculated static ID to the node determining unit 332.

Upon receiving the static ID of the data from the ID calculator 331, the node determining unit 332 determines the node 200 of “A3” as the destination of the update request based on the static ID of the data and the ID node information stored on the ID node information storage unit 322. The node determining unit 332 transmits the update request to the determined node 200 of “A3” (S10).

The ID calculator 231 of the node 200 of “A3” receives the update request from the accumulation client 300 and calculates the static ID of the data. The ID calculator 231 calculates the static ID of the data based on the key of the data included in the request and the static area information stored on the static area information storage unit 221. The ID calculator 231 outputs the static ID of the generated data to the ID converter 232 and the determining unit 233.

The determining unit 233 in the node 200 of “A3” receives the update request of the data from the accumulation client 300. The determining unit 233 receives the static ID of the data from the ID calculator 231. The determining unit 233 searches the data storage unit 224 for the static ID and the key of the data of the update request. In accordance with the search results, the determining unit 233 determines whether data corresponding to the update request is stored on the data storage unit 224. Since the data responsive to the update request is not stored on the data storage unit 224, the determining unit 233 searches the location storage unit 225 for the static ID and the key of the data of the update request. In accordance with the search results, the determining unit 233 determines whether the node 200 as the transfer destination is stored on the location storage unit 225.

Since the node 200 as the transfer destination responsive to the update request is not stored on the location storage unit 225, the determining unit 233 outputs the dynamic area information to the ID converter 232. Upon receiving the dynamic area information from the determining unit 233, the ID converter 232 converts the static ID of the data into a dynamic ID. The ID converter 232 calculates the dynamic ID of the data based on the primary ID from which the static ID range has been calculated, and the dynamic area information stored on the dynamic area information storage unit 223. The ID converter 232 outputs the calculated dynamic ID of the data to the determining unit 233.

Upon receiving the dynamic ID of the data from the ID converter 232, the determining unit 233 references the ID node information stored on the ID node information storage unit 222. The determining unit 233 determines the node 200 of “B2” to which the static ID corresponding to the dynamic ID of the data is allocated. The determining unit 233 stores on the location storage unit 225 the determined node 200 of “B2” as the transfer destination node “B2”. The determining unit 233 transfers the update request to the transfer destination node 200 of “B2” having the determined update request (S11).

Upon receiving the update request transferred from the node 200 of “A3”, the redistribution unit 234 of the node 200 of “B2” allows the data to be transmitted to the accumulation client 300 as the transmission source of the update request. The redistribution unit 234 receives the data and stores the data on the redistribution storage unit 226. Upon transmitting the data to the redistribution storage unit 226, the redistribution unit 234 transmits an update response to the node 200 of “A3” as the transfer source (S12).

The determining unit 233 of the node 200 of “A3” receives the update response from the node 200 of “B2” as the transfer destination, and then transfers the update response to the accumulation client 300 (S13). Upon receiving the update response, the accumulation client 300 detects the completion of the accumulation process of the data.

The operation of the reference request is described below. If a reference request of data is created, the ID calculator 431 in the analysis server 400 calculates the static ID of the data based on the key of the data and the static area information stored on the static area information storage unit 421. The ID calculator 431 outputs the calculated static ID of the data to the node determining unit 432.

The node determining unit 432 receives the static ID of the data from the ID calculator 431, and determines the node 200 of “A3” as the destination of the reference request based on the static ID of the data and the ID node information stored on the ID node information storage unit 422. The node determining unit 432 transmits the reference request to the determined node 200 of “A3” (S14).

Upon receiving the reference request of the data from the analysis server 400, the ID calculator 231 in the node 200 of “A3” calculates the static ID of the data. The ID calculator 231 calculates the static ID of the data based on the key of the data included in the reference request and the static area information stored on the static area information storage unit 221. The ID calculator 231 outputs the calculated static ID of the data to the ID converter 232 and the determining unit 233.

The determining unit 233 in the node 200 of “A3” receives the reference request of the data from the analysis server 400. The determining unit 233 receives the static ID of the data from the ID calculator 231. The determining unit 233 searches the data storage unit 224 for the static ID and the key of the data of the reference request. In accordance with the search results, the determining unit 233 determines whether the data responsive to the reference request is stored on the data storage unit 224. Since the data responsive to the reference request is not stored on the data storage unit 224, the determining unit 233 searches the location storage unit 225 for the static ID and the key of the data of the reference request. In accordance with the search results, the determining unit 233 determines whether the node 200 as the transfer destination is stored on the location storage unit 225.

If the node 200 of “B2” as the transfer destination responsive to the reference request is stored on the location storage unit 225, the determining unit 233 transfers the reference request to the node 200 of “B2” as the transfer destination of the reference request (S15).

Upon receiving the reference request from the node 200 of “A3”, the redistribution unit 234 in the node 200 of “B2” reads from the redistribution storage unit 226 the data responsive to the reference request, and then transmits the data to the analysis server 400. Upon transmitting the data to the analysis server 400, the redistribution unit 234 transmits a reference response to the node 200 of “A3” (S16).

Upon receiving the reference response from the node 200 of “B2” as the transfer destination, the determining unit 233 in the node 200 of “A3” transfers the reference response to the analysis server 400 (S17). In response to the reception of the reference response, the analysis server 400 detects the completion of the data reading operation.

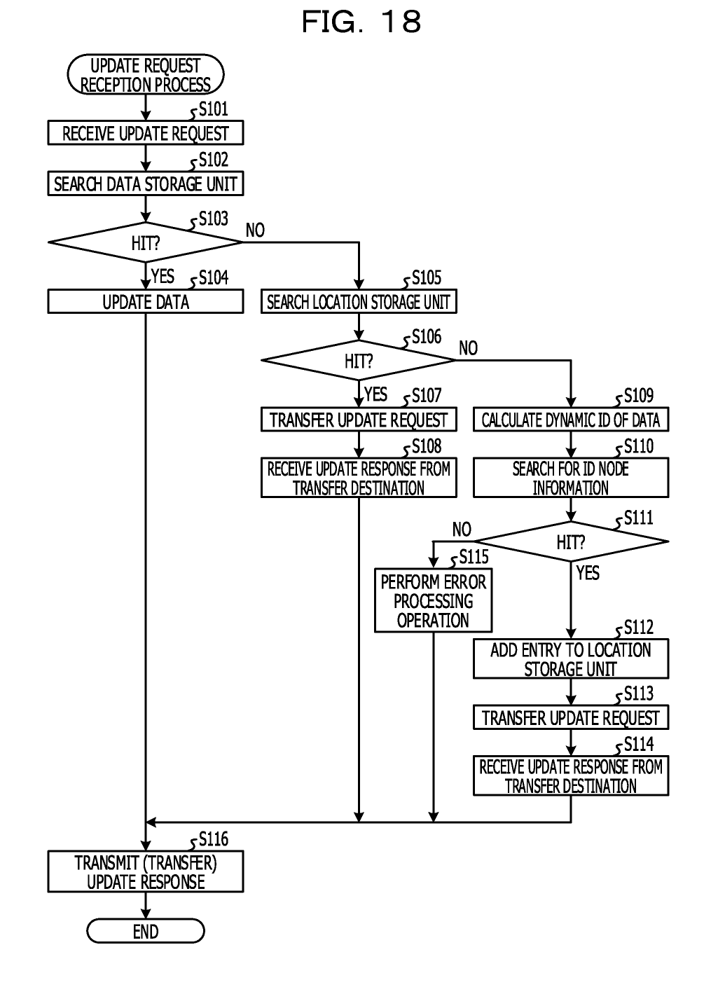

The operation of the node 200 for the reception of an update request is described in detail below. FIG. 18 is a flowchart illustrating an operation example of the node of the embodiment during the update request reception.

The ID calculator 231 in the node 200 receives from the accumulation client 300 a request to update the data (S101). The ID calculator 231 calculates the static ID of the data based on the key of the data included in the request and the static area information stored on the static area information storage unit 221. The ID calculator 231 outputs the calculated static ID of the data to the ID converter 232 and the determining unit 233.

The determining unit 233 receives from the accumulation client 300 a request to update the data. The request includes the key of the data. The determining unit 233 receives the static ID of the data as an update target from the ID calculator 231. The determining unit 233 searches the data storage unit 224 the data responsive to the static ID and the key (S102). In accordance with the search results, the determining unit 233 determines whether the data responsive to the update request has been hit (S103). If the data responsive to the update request has been hit (yes branch from S103), the determining unit 233 updates the data stored on the data storage unit 224 (S104). Upon updating the data, the determining unit 233 transmits an update response to the accumulation client 300 (S116).

If the data responsive to the update request has not been hit (no branch from S103), the determining unit 233 searches the location storage unit 225 for the node 200 as the transfer destination responsive to the update request based on the static ID and the key of the data of the reference request (S105). In accordance with the search results on the location storage unit 225, the determining unit 233 determines whether the node 200 as the transfer destination responsive to the update request has been hit (S106). If the node 200 as the transfer destination responsive to the update request has been hit (yes branch from S106), the determining unit 233 transfers the update request to the transfer destination node 200 (S107). Upon receiving an update response from the transfer destination node 200 (S108), the determining unit 233 proceeds to S116 to transfer the update response to the accumulation client 300.

If the transfer destination node 200 responsive to the update request has not been hit (no branch from S106), the determining unit 233 outputs the dynamic ID of the data to the ID converter 232. In response to the reception of the dynamic ID of the data from the determining unit 233, the ID converter 232 calculates the dynamic ID of the data based on the primary ID from which the static ID of the data has been calculated, and the dynamic area information stored on the dynamic area information storage unit 223 (S109). The ID converter 232 outputs the calculated dynamic ID of the data to the determining unit 233.

Upon receiving the dynamic ID of the data from the ID converter 232, the determining unit 233 searches the ID node information storage unit 222 for the ID node information (S110). In accordance with the search results on the ID node information, the determining unit 233 determines whether the static ID responsive to the dynamic ID of the data has been hit (S111). If the static ID responsive to the dynamic ID of the data has been hit (yes branch from S111), the determining unit 233 determines the node 200 having the static ID responsive to the dynamic ID of the data allocated thereto as the transfer destination node 200. The determining unit 233 sets the determined node 200 to be a transfer destination node 200, and adds the transfer destination node 200 as an entry on the location storage unit 225 (S112). The determining unit 233 transfers the update request to the node 200 (S113). Upon receiving an update response from the transfer destination node 200 (S114), the determining unit 233 proceeds to S116 to transfer the update response to the accumulation client 300.

If the static ID responsive to the dynamic ID of the data has not been hit (no branch from S111), the determining unit 233 executes an error processing operation (S115). The determining unit 233 proceeds to step S116 to transmit the results of the error processing operation as an update response to the accumulation client 300.

If the responsive to the update request has been hit by searching the data storage unit 224, the node 200 updates the data stored on the data storage unit 224. As a result, the generation of transfer traffic of the request across the areas is controlled.

The node 200 references the location storage unit 225. If the transfer destination node 200 corresponding to the update request is hit, the node 200 transfers the update request to the transfer destination node 200. Regardless of whether the update request is transferred or not, the accumulation client 300 updates the data on the transfer destination node 200 by transmitting the request to the transfer source node 200.

The node 200 references the ID node information storage unit 222. If the static ID responsive to the dynamic ID of the data has been hit, the node 200 determines as the transfer destination node 200 the node 200 to which the static ID responsive to the dynamic ID of the data is allocated. As a result, the node 200 used in each area is managed within the dynamic ID range of each area using the dynamic area information. Management costs involved in the management of the distributed DB group are reduced.

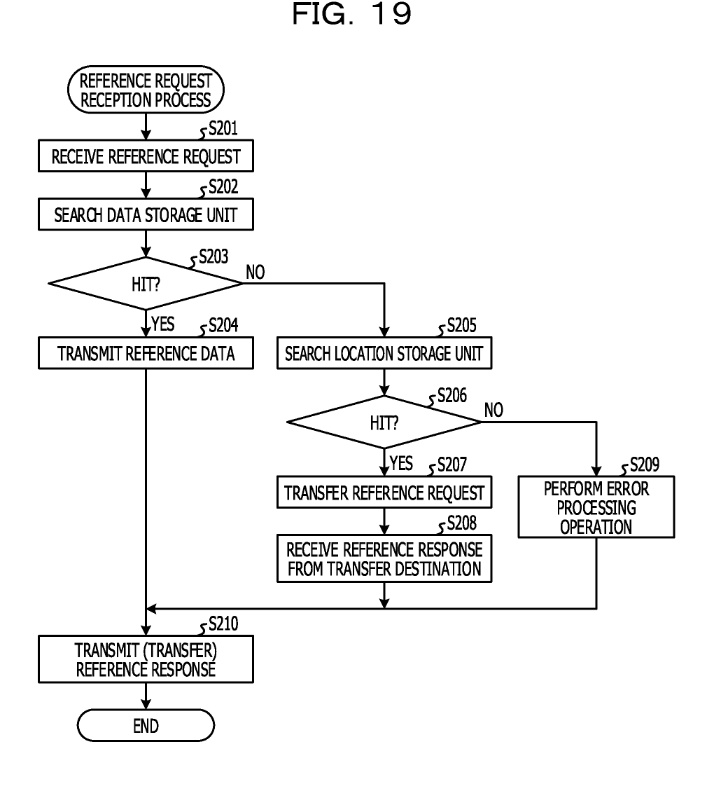

The operation of the node 200 for the reference request reception is described in detail. FIG. 19 is a flowchart illustrating an operation example of the node of the embodiment for the reference request reception.

The ID calculator 231 in the node 200 receives from the analysis server 400 the request to reference the data (S201). The ID calculator 231 calculates the static ID of the data based on the key of the data included in the reference request and the dynamic area information stored on the statistic area information storage unit 221. The ID calculator 231 outputs the calculated static ID of the data to the ID converter 232 and the determining unit 233.

The determining unit 233 receives from the analysis server 400 the request to reference the data. The determining unit 233 receives the static ID of the data from the ID calculator 231. The determining unit 233 searches the data storage unit 224 for the static ID and the key of the data of the reference request (S202). In accordance with the search results, the determining unit 233 determines whether the data responsive to the reference request has been hit (S203). If the data responsive to the reference request has been hit (yes branch from S203), the determining unit 233 reads the data stored on the data storage unit 224 and then transfers the data to the analysis server 400 (S204). Upon transmitting the data, the determining unit 233 transmits an update response to the analysis server 400 (S210).

If the data responsive to the reference request has not been hit (no branch from S203), the determining unit 233 searches the location storage unit 225 for the static ID and the key of the data of the reference request (S205). In accordance with the search results, the determining unit 233 determines whether the node 200 as the transfer destination has been hit (S206). If the transfer destination node 200 has been hit (yes branch from S206), the determining unit 233 transfers the reference request to the transfer destination node 200 (S207). Upon receiving a reference response from the transfer destination node 200 (S208), the determining unit 233 proceeds to S210 to transfer the reference response to the analysis server 400.

If the transfer destination node 200 responsive to the reference request has not been hit (no branch from S206), the determining unit 233 performs an error processing operation (S209). The determining unit 233 proceeds to S210 to transmit a result of the error processing operation as a reference response to the analysis server 400.

If the data responsive to the reference request has been hit by referencing the data storage unit 224, the node 200 references the data stored on the data storage unit 224. As a result, the generation of transfer traffic of the request across the areas is controlled.

If the transfer destination node 200 corresponding to the reference request has been hit by referencing the location storage unit 225, the node 200 transfers the reference request to the transfer destination node 200. As a result, regardless of whether the reference request is transferred or not, the analysis server 400 updates the data on the transfer destination node 200 by transmitting the request to the transfer source node 200.

In the data management system 10, the node 200 receives the ID node information and the dynamic area information from the management node 100. Upon detecting the update request, the node 200 calculates the dynamic ID based on the ID node information and the dynamic area information. The node 200 determines the node 200 that stores the data of the update request corresponding to the calculated dynamic ID, by referencing the ID node information. If a determined node 200 is a node 200 in another area, the node 200 transfers the update request to the node 200 in the other area. As a result, the data management system 10 provides an increased resource usage rate.

The management node 100 collects an amount of load from each node 200 in all the areas. Upon detecting a node 200 having a collected amount of load above the specific amount of load, the management node 100 generates the dynamic area information by adding, to the static ID range of the area including the node 200 having the amount of load above the specific amount of load, the static ID area in an area adjacent to the area including the node 200 having the amount of load above the specific amount of load. As a result, the data management system 10 may use a resource in the adjacent area.

The management node 100 generates, on a per area basis, the ID node information by associating the static ID range responsive to the dynamic ID in each area with the node 200 allocated to the static ID range. As a result, the data management system 10 may determine the area and the node 200 belonging to the area in accordance with the static ID range.

Upon detecting the reference request to reference the data, the node 200 calculates the static ID based on the character string representing part of the data of the reference request and the ID node information. The node 200 determines a node 200 which references the data of the reference request and corresponds to the calculated static ID, by referencing the ID node information. In the same manner as in the detection of the update request, the node 200 transfers the reference request to the determined node 200. As a result, the data management system 10 provides an increased resource usage rate.

The node 200 calculates the primary ID of the data of the update request or the reference request based on the character string representing part of the data of the update request or the reference request using the hash function. The node 200 calculates the static ID of the data of the update request or the reference request based on the primary ID and the static ID range of the ID node information. The node 200 searches the data storage unit 224 for the data corresponding to the static ID of the data of the update request or the reference request and corresponding to the character string. If the data is stored on the data storage unit 224, the node 200 determines itself as the node 200 that is to store or reference the data of the update request or the reference request. The node 200 updates or references the data on the data storage unit 224. If the load of the distributed DB node group of all the areas is lower in the data management system 10, only the nodes 200 in each area may store the data. For this reason, the data management system 10 controls the generation of transfer traffic across the areas.

If the data of the update request or the reference request is not stored on the data storage unit 224, the node 200 searches the location storage unit 225 storing the transfer destination node 200 for the node 200 corresponding to the static ID of the update request or the reference request and the character string. If the corresponding node 200 is stored on the location storage unit 225, the node 200 determines as the node 200 belonging to another area the node 200 that stores or references the data of the update request or the reference request. The node 200 transfers the update request or the reference request to the determined node 200. As a result, the data management system 10 may update or reference the data transferred to the node 200 in the other area depending on the load by transmitting the update request or the reference request to the transfer source node 200.

If the transfer destination node 200 is not stored on the location storage unit 225, the node 200 calculates the dynamic ID of the data of the update request based on the primary ID and the dynamic area information. By referencing the ID node information, the node 200 determines as the node 200 configured to store the data of the update request the node 200 to which the static ID corresponding to the calculated dynamic ID of the data of the update request is allocated. The node 200 stores the determined node 200 on the location storage unit 225 while transferring the update request to the determined node 200. As a result, the data management system 10 manages the data transferred by the transfer source node 200, thereby making the location management of the data scalable. The data management system 10 manages the node 200 used in each area in accordance with the dynamic ID range of each area using the dynamic area information. The data management system 10 reduces costs in managing the distributed DB node group.

In the above embodiment, the number of area is four, and the number of nodes 200 belonging to each area is three. The number of nodes 200 is not limited to three. The number of areas and the number of nodes 200 may be increased or decreased as appropriate depending on an amount of accumulated data.

In the above embodiment, the range of the static ID and the dynamic ID is “1-1000”. The range of the static ID and the dynamic ID is not limited to “1-1000”. The range of the static ID and the dynamic ID may be increased or decreased as appropriate depending on the number of nodes 200 in each area.

The elements in each unit do not necessarily have to be physically arranged as illustrated in the drawings. The distribution and integration of the elements in each unit are not limited to those specifically described in the drawings. All or some of the elements may be distributed or integrated functionally or physically by any unit depending on operation load and usage status.

All or some of a variety of processes and functions may be performed on a CPU, an MPU, or a micro controller unit (MCU). All or some of the processes and functions may be performed on a program analyzed or executed on the CPU, the MPU, or the MCU, or may be performed on hardware of wired logic.

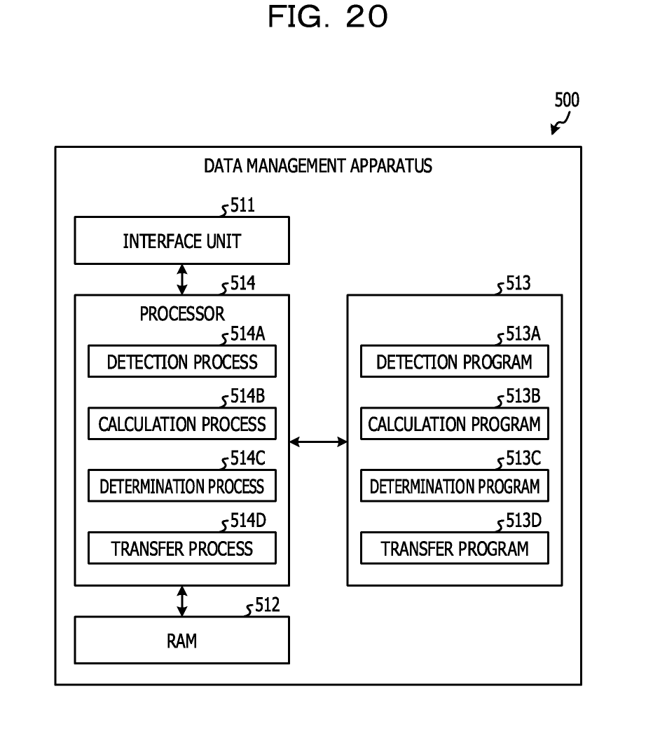

Each of the processes described in the embodiment may be implemented by executing a prepared program on a data management apparatus. An example of the data management apparatus that executes a program having the same functions as those of the embodiment is described below. FIG. 20 illustrates an example of a data management apparatus that executes a data management program.

The data management apparatus 500 that executes the data management program of FIG. 20 includes an interface unit 511, a random-access memory (RAM) 512, a read-only memory (ROM) 513, and a processor 514. The interface unit 511 communicates with a management apparatus, an accumulation apparatus, an analysis apparatus, and other data management apparatuses. The processor 514 controls the entire data management apparatus 500.

The ROM 513 pre-stores the data management program having the same functions as those of the embodiment. The data management program may be stored on a recording medium that may be read by a drive (not illustrated), instead of the ROM 513. The recording medium may be a removable medium, such as a compact disk ROM (CD-ROM), a digital versatile disk (DVD), or a Universal Serial Bus (USB) memory, or a semiconductor memory, such as a flash memory. The data management program may include a detection program 513A, a calculation program 513B, a determination program 513C, and a transfer program 513D as illustrated in FIG. 20. The programs 513A through 513D may be integrated or distributed. The RAM 512 may store the static area information, the ID node information, the dynamic area information, the accumulation information, and a database that stores a location of the transferred accumulation data and the transferred accumulation data itself.

The processor 514 reads these programs 513A through 513D from the ROM 513 and executes each of the read programs. As illustrated in FIG. 20, the processor 514 causes the programs 513A through 514D to be executed as a detection process 514A, a calculation process 514B, a determination process 514C, and a transfer process 514D respectively as illustrated in FIG. 20.

The data management apparatus 500 receives the ID ranges of all the areas, and the derivation enabled range from which the first ID calculated from the data of the update request to update the accumulated data is derived. The processor 514 detects the update request. If the update request is detected, the processor 514 calculates the first ID from the data of the update request based on the ID range of all the areas and the derivation enabled range. The processor 514 references the node information that associates the first ID with the first node and determines the first node that stores the data of the update request responsive to the calculated first ID. If the determined node is a node in another area, the processor 514 transfers the update request to the determined node. As a result, the resource usage rate is increased.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A data management method of a data management system including a plurality of computers capable communication over a network, and a management computer configured to manage the computers over the network, the computers belonging to respective areas, first identification ranges representing ranges of identifier values, the first identification ranges respectively allocated to the plurality of computers, the data management method comprising:
acquiring, by the management computer, information of an amount of resource load from the plurality of computers;
when a first computer among the plurality of computers and having a higher amount of load than a threshold value is detected in a first area to which the first computer belongs, generating, by the management computer, a second identification range of identifier values by adding a first identification range of the first area to which the first computer belongs to a first identification range of a second area different from the first area;
calculating, by the first computer, a first target identification of a second computer among the plurality of computers in the second area corresponding to first data, based on the first identification ranges and the second identification range, when an operation request for first data is received; and
transferring, by the first computer, the operation request for the first data to the second computer.

2. The data management method according to claim 1, wherein the generating of the second identification range comprises allocating the same identification range as the first identification range to each of the plurality of areas when a computer having a higher amount of load than the threshold value is not detected from among the plurality of computers.

3. The data management method according to claim 1, wherein the calculating of the first target identification comprises:
calculating a primary identification of first data based on a character string name for the first computer included in the operation request for the first data using a hash function; and
adding a start point identifier value of the second identification range to a result of dividing a product of the primary identification and an end point identifier value of the second identification range by a largest identifier value of the first identification ranges.

4. The data management method according to claim 1, further comprising:
determining, by the first computer, whether the first data is stored in a memory, when the operation request for the first data is received;
performing a process with regard to the first data when the first data is stored in the memory;
determining whether information of the second computer for the first data is stored in the memory, when the first data is not stored in the memory;
transferring the operation request for the first data to the second computer, when the information of the second computer is stored; and
executing the calculating of the first target identification and the transferring of the operation request for the first data to the second computer, when the information the second computer is not stored in the memory.

5. The data management method according to claim 1, further comprising:
when a reference request as the operation request to reference second data is received, calculating, by the first computer, a second target identification corresponding to the second data based on the node information and a key of the second data included in the reference request;
extracting, by the first computer, a third computer among the plurality of computers, the third computer being corresponding to the key and the second target identification, by referencing the node information stored in the memory; and
transferring the reference request to the third computer.

6. The data management method according to claim 5, wherein the calculating of the second target identification comprises:
calculating a primary identification of the second data based on a character string included in the reference request using a hash function; and
adding an identification of a start point of the first identification range in the area to which the first computer belongs to a value that results from dividing a product of the primary identification and a width of the first identification range by a width of the entire identification range.

7. The data management method according to claim 5, further comprising:
determining, by the first computer, whether information of a transfer destination of the second data is stored in the memory, when the second data is not stored in the memory;
transferring, by the first computer, the reference request to the transfer destination, when the information of the transfer destination of the second data is stored in the memory; and
outputting, by the first computer, an error message, when the information of the transfer destination of the second data is not stored in the memory.

8. The data management method according to claim 1,
wherein the generating includes increasing, by the management computer, a first identification range for the first area by generating a second identification range including a second area different from the first area, the second identification range causing the first computer in the first area to transfer an operation request for data not hittable in the first computer, to the second computer in the second area.

9. The data management method according to claim 1,
wherein the calculating includes calculating, by the first computer, identification of the second computer in the second area corresponding to the first area, based on the first identification range and the second identification range, to transfer the operation request for the first data when the operation request for the first data is received.

10. A data management system, comprising:
a plurality of computers capable communication over a network, the plurality of computers belonging to respective areas, first identification ranges representing ranges of identifier values, the first identification ranges respectively allocated to the plurality of areas; and
a management computer configured to manage the plurality of computers, the management computer comprising:
a first memory, and
a first processor coupled to the first memory and configured to:
acquire information of an amount of resource load from the plurality of computers,
when a first computer having the amount of load higher than a threshold value is detected in a first area to which the first computer belongs, generate a second identification range of identifier values by adding a first identification range of the first area to which the detected first computer belongs to a first identification range of a second area different from the first area, and
wherein a first computer included in the plurality of computers comprises:
a second memory, and
a second processor coupled to the second memory and configured to:
receive, from the management computer, information of an entire identification range indicating the identification ranges of all the areas and information of the second identification range,
calculate a first target identification corresponding to the first data to be updated, based on the entire identification range and the second identification range, when an operation request for the first data is received,
extract a second computer from among the plurality of computers corresponding to the first target identification, and
transfer the operation request for the first data to the second computer.

11. The data management system according to claim 10, wherein
the first processor is configured to transmit node information that associates the first identifier range to a computer corresponding to the first identification range; and
the second processor is configured to store the received node information in a memory.

12. The data management system according to claim 11, wherein the first processor is configured to generate the second identification range by allocating the same identification range as the first identification range to each of the plurality of areas when a computer having a higher amount of load than the threshold value is not detected from among the plurality of computers.

13. The data management system according to claim 11, wherein the second processor is configured to:
calculate the first target identification by calculating a primary identification of second data based on a character string included in the operation request using a hash function; and
add an identification of a start point of the second identification range to a value that results from dividing a product of the primary identification and a width of the second identification range by a width of the entire identification range.

14. The data management system according to claim 10, wherein the second processor is configured to
determine whether the first data is stored in a memory, when an update request as the operation request is received;
update the first data when it is determined that the first data is stored in the memory;
determine whether information of a transfer destination of the first data is stored in the memory, when it is determined that the first data is not stored in the memory;
transfer the update request to the transfer destination, when it is determined that the information of the transfer destination is stored; and
execute an operation to calculate the first target identification, an operation to retrieve the information of the second computer, and an operation to transfer the update request to the second computer, when it is determined that the information of the transfer destination is not stored.

15. A data management apparatus configured to manage a plurality of computers capable communication over a network, the computers belonging to respective areas, first identification ranges representing ranges of identifier values, the first identification ranges respectively allocated to the plurality of areas, the data management apparatus comprising:
a memory, and
a processor coupled to the memory and configured to:
acquire information of an amount of resource load from each of the computers,
when a first computer having a higher amount of load than a threshold value is detected in a first area to which the first computer belongs, generate a second identification range of identifier values by adding, a first identification range of the first area to which the detected first computer belongs to a first identification range of a second area different from the first area, and
transmit information of the entire identification ranges of all the areas and information of the second identification range to the computers.
